(19) United States
(12) Patent Application Publication
(10) Pub. No.: US 2005/0229360 A1
(43) Pub. Date: Oct. 20, 2005

(54) Hinge

(76) Inventor: Mark Jeffrey Lowe, Bossier City, LA (US)

Correspondence Address: Christopher D. Harrington;Harrington Law Offices, 447 Ada Drive SE, Ada, MI, 49301, US

(21) Appl. No.: 10/824,791

(22) Filed: Apr. 15, 2004

(51) Int. Cl. E05F 1/08

(52) U.S. Cl. 16/335

(57) ABSTRACT

A hinge for use in securing a door to a cabinet, includes a hinge cup portion for installation onto a door, a hinge arm portion for installation onto a cabinet, a spring for rotatable connection between said hinge arm portion and said hinge cup portion, where the spring is capable of exerting a first biasing force for urging the door to a fully closed or fully open position, and a second biasing force for exerting non-linear tension on the spring at a predetermined position during the progression of the door between an open and a closed position.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a new hinge for furniture products. More particularly, the present invention relates to a compact hinge that is used primarily for mounting doors onto a cabinet.

Furniture hinges have evolved in the last thirty years to become smaller in size, easier to install and adjust, and with increased functionality such as providing a self-closing force to a door, or quick disconnection between a door and a cabinet. One of the types of hinges that has become very popular in this regard is termed a “compact” hinge for the reason that it relatively moderate in size, but also because it can be installed between a door and a cabinet in a way that is very unobtrusive.

Compact hinges of the type discussed herein, are typified by a cup portion that mounts into a recess cut into a door, and an arm portion that is pivotably connected to the cup portion and is also mounted to a portion of the cabinet. Examples of compact hinges may be seen, for example, in U.S. Pat. No. 5,617,612 to Ferrari, in U.S. Pat. No. 5,604,956 to Grass, and in U.S. Pat. No. RE 34,995 which is a re-exam patent (U.S. Pat. No. 5,175,908) to Domenig.

The compact hinges continue to evolve in ways to provide easier operation and adjustment, more efficient construction, and other features that make them very desirable as components of furniture and other products.

### SUMMARY OF THE INVENTION

A compact hinge of the present invention comprises a cup portion and a hinge portion, where the hinge portion is pivotably connected to the cup portion. The hinge portion is comprised of an arm that extends from an arm end that engages a hinge pin within the cup portion and bracket end that is mountable onto a cabinet frame. The hinge assembly also includes a biasing spring that works on the arm end to bias the hinge portion towards a closed or open position.

The compact hinge of the present invention includes a biasing spring that is mounted outside the hinge cup.

The compact hinge of the present invention includes a biasing spring that can be set for a desired tension.

The compact hinge of the present invention also includes a more efficient design than the prior art with fewer components and components with less working.

These and other attributes and features of the present invention will be disclosed in more detail below.

### BRIEF DESCRIPTION OF THE DRAWINGS

FIG. 1 shows a perspective view of the compact hinge of the present invention

FIG. 2 shows an exploded perspective view of a compact hinge of the present invention.

FIG. 3 shows a top view of a compact hinge of the present invention.

FIG. 4 is a side elevational view of a compact hinge of the present invention.

FIG. 5 is a rear elevational view of a compact hinge of the present invention.

FIG. 6 is a side elevational view of the arm portion of a compact hinge of the present invention.

### DETAILED DESCRIPTION OF THE INVENTION

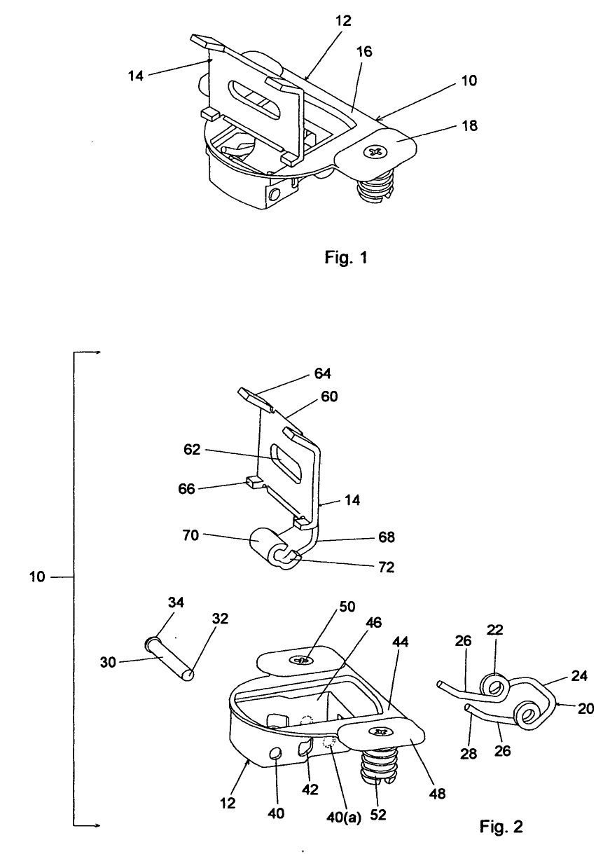

A compact hinge 10 in accordance with the present invention is shown generally in FIG. 1 with hinge cup 12, hinge arm 14, cup apron 16 and cup flanges 18. In this portrayal, the hinge is shown in the closed position which is achieved through a biased action that will be described further below.

The components of the hinge are seen in more detail in FIG. 2, where surprisingly few such components are needed to complete the invention. As shown, the hinge 10 is also comprised of the spring 20 which includes the spring coils 22, the intermediate spring portion 24, the spring arm(s) 26 and the spring end(s) 28. The assembly also includes the hinge pin 30, with pin end 32 and pinhead 34.

Turning now to the hinge cup 12, the hinge pin hole(s) 40 are shown as are phantom hinge pin hole(s) 40(a) which will be explained in more detail below. In addition, the access hole(s) 42, the hinge cup flange 44, the hinge cup interior 46, the mounting flanges 48, fastener 50 and plug 52 are all disclosed.

The last component of the hinge is the hinge arm 14 which includes the bracket 60, the mounting hole 62, the angled stops 64, the straight stops 66, the intermediate arm 68, and the arm end 70 with the cam surfaces 72.

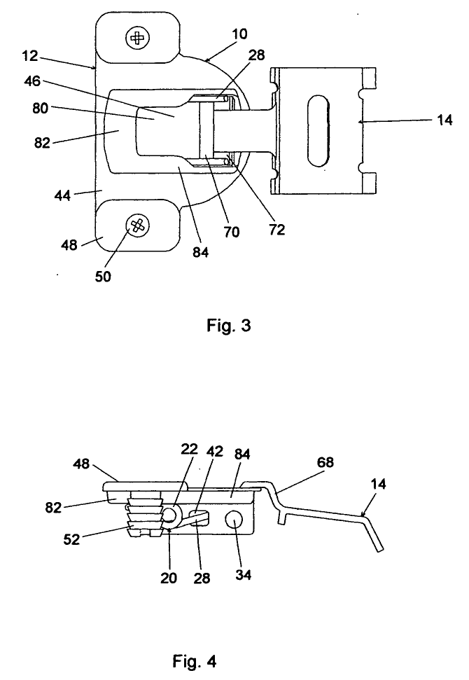

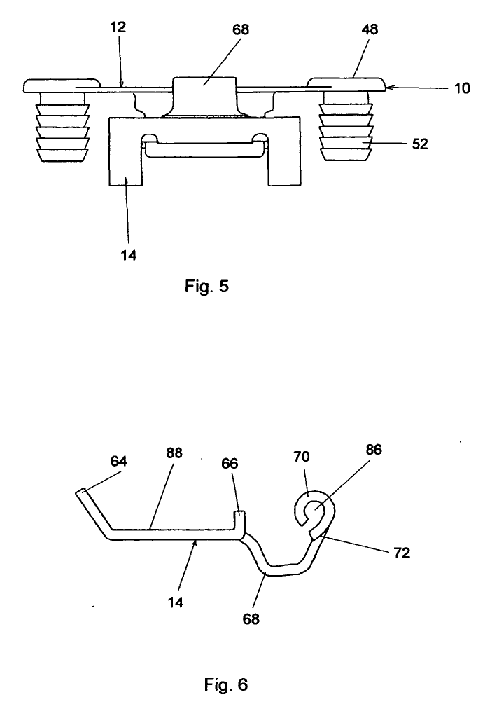

FIGS. 3, 4 and 5, all show the compact hinge of the present invention in different views, with the hinge cup floor 80, the spring cowl 82 and the cowl sides 84 now visible.

FIG. 6 shows the hinge arm 14 in isolation, with the through hole 86 and the mounting surface 88.

In use, the compact hinge is mounted onto a door by first having a recess routed out in the door itself This recess is compatibly sized to accept the hinge cup with the hinge cup flanges and the mounting flanges resting on top of the door surface. The installation of the hinge cup may be completed by insertion of the plugs into predrilled holes located for that purpose, and then tightening same down by insertion and threading of the fasteners into the plugs, expanding them into the receiving holes. As may be appreciated, this occurs on the inside surface of the typical cabinet door and in locations roughly adjacent to the cabinet front where the corresponding hinge arm part may then be fitted onto the edge of a cabinet face or frame. This method of mounting is typical for compact hinges and as such is not part of the present invention per se.

The hinge operates between an open and a closed position where the hinge arm is free to rotate about the hinge pin as may be understood and seen as between FIGS. 1 and 3 (closed and open positions respectively). The spring, through the spring arms and spring ends, provides the biasing action onto the cam surfaces of the hinge arm. When the door is brought within a distance to an open or a closed position, the bias is generated by the action of the spring arm and spring end on the cam surface, resulting in the case of the present invention, coordinated closing force or opening force. Again, the usage of the spring arms and spring ends in this fashion is somewhat similar to applications shown in the prior art, however, as will be noted below, the tension generated on the spring arms and the spring ends can be selected in the present invention which is substantially different from the prior art designs.

Continuing, the hinge arm is mounted onto a front frame edge of a cabinet in the typical application, where the mounting surface sits directly on the frame edge and the position of the hinge arm is made vertically adjustable by means of the mounting hole. The bracket portion of the hinge arm is guided somewhat by the angled stops and the straight stops which help to plant the bracket squarely onto the surface of the frame edge. The angled stops serve the purpose of handling non-uniform thicknesses in the frame itself thus allowing the stops to work even when the material making up the frame is slightly oversized.

Of interest in the present invention is the usage of a single hinge pin. The hinge pin is installed into the hinge pin holes and is rotatably fixed by heading the pin end after the hinge pin has been threaded through arm end by means of the through hole. The spring on the other hand, does not require a hinge pin in the present invention. The phantom hinge pinholes 40(a) as shown in FIG. 2 represent the position where a second hinge pin would normally be installed in the prior art hinges. The placement of the spring, substantially outboard of the hinge cup, obviates the need for this second hinge pin and simplifies the assembly process tremendously. As shown, the intermediate portion of the spring and the spring coils reside under the spring cowl and the cowl sides respectively. While not shown, the intermediate portion of the spring is typically fastened to the hinge cup by means of a tab turned up from the rear wall of the hinge cup. This will retain the spring in place.

The spring arms project along the sidewalls of the hinge cup and enter the access holes. The spring arms are installed to contact the cam surfaces of the hinge arm and when they do so, there is a small amount of tension exerted (if nothing more than the weight of the spring arms) onto the cam surfaces which increases as the cam action progresses to a maximum and then back to a minimum as the door is correspondingly opened (or closed). At this point, the present invention achieves a novel result in that the spring arms have spring coil tensioning without resort to using the interference effect of the underside of a cowl side as is shown in the prior art. The importance of this lies in the variability of the effect desired, since without more, the number of coils can be changed to alter the tensioning. Spring coil tensioning is preferred since it is essentially linear over a large part of the tension curve. If only interference is used to bias a spring arm it is non-linear and may result in undesirable fluctuations of “feel” as the hinge is progressed through open and closed positions.

The tensioning on the spring arms can also be augmented by the access holes. The amount of vertical clearance given to the spring arm travel, upwardly and downwardly, can supply a pre-set interference tension to the spring arms. Unlike prior art devices which use the underside of the cowl sides to perform this task; the access holes provide a way to alter the amount of tension for given applications. For instance, it would be possible to produce a hinge with stronger tensioning, hence bias, if the access hole is shortened vertically. In doing this, the spring arms will contact the top of the access hole sooner (or later in the opposite scenario) which will provide immediate resistance to the travel of the spring arm, decreasing the length of the lever arm between the spring and the cam surfaces. The amount of biasing forces then increases dramatically under this condition resulting in a multi-staged effect when the spring ends work on the cam surfaces, with the biasing force remaining constant during the time that tensioning remains linear (spring coils) and rising and falling in non-linear fashion as contact is made or released with the top of the access holes. Changes in the non-linear biasing force can be achieved easily by changing the punch that makes the access hole, as compared to the alteration of the height of the cowl sides which would require a complete new set of tooling.

The present invention allows for the usage of one type of spring and one set of tools for the production of hinges that can be matched to given applications. This surprising result increases the efficiency in manufacturing and handling of the present invention, which is further enhanced by the reduction of the second hinge pin. Taken as a whole, substantially less components are needed for the compact hinge taught herein yet it provides at least the equivalent functionality as compared to those in the prior art and yet it can also be adjusted to provide multi-staged tensioning for differing loads and applications.

The compact hinge of the present invention may be varied without departing from the teachings herein. For instance, the usage of the second hinge pin, although redundant, could still be considered in conjunction with the variable tensioning afforded by the combination of the spring coils and the access holes. The hinge arm could be varied in ways to modify the bracket or the arm end without departing from the spirit and scope of the teachings herein. The usage of the spring coils separately, without the effect of a second stage, non-linear effect being contributed from the contact with the access holes would also be a desirable variation, resulting in a compact hinge that only had a single stage effect while retaining the economical design described above.

Although it is understood that the bulk of the construction of the present invention is preferably fabricated from metal components, where desired, plastic components could be used where it is a matter of compatible selection by one skilled in the art.

1. A hinge comprising:
A hinge cup portion for mounting onto a door;
A hinge arm portion for mounting onto a cabinet;
Said hinge cup portion and said hinge arm portion being rotatably connected;
A spring with at least one spring arm and at least one spring coil where said spring arm is tensioned by the spring coil, said spring being mounted substantially outboard of said hinge cup portion, where said spring arm exerts a biasing force on said hinge arm portion for urging said hinge to a closed position when said hinge is progressed towards a closed position, and for urging said hinge arm portion to an open position when said hinge is progressed towards an open position;
And where the assembly of said hinge arm portion, said hinge cup portion and said spring requires only one hinge pin.

2. The hinge as in claim Number 1, wherein the biasing force is substantially linear.

3. The hinge as in claim Number 2 wherein said spring arm is capable of exerting a first linear biasing force and a second non-linear biasing force, where said non-linear biasing force occurs at a predetermined position during the progression of the hinge between an open position and a closed position.

4. A hinge comprising:
A hinge arm portion affixed to a cabinet and a hinge cup portion affixed to a door, where said hinge arm portion and hinge cup portion are rotatably connected;
A spring acting between said hinge arm portion and said hinge cup portion to provide a biased closing force or a biased opening force;
Where said biased closing force or said biased opening force is initially applied in a substantially linear effect to the closing or opening of the hinge and where said biasing forces can be selectively applied in a non-linear effect at a predetermined position during the closing or opening of the hinge.

5. The hinge of claim Number 4, where the hinge includes both a biased closing force and a biased opening force.

6. The hinge of claim Number 4, where the non-linear biased force may be selectively increased or decreased.

7. The hinge of claim Number 4, where said hinge arm portion and said hinge cup portion and said spring can be assembled with one hinge pin.

8. A hinge comprising:
A hinge cup portion for mounting onto a door;
A hinge arm portion for mounting onto a cabinet;
Said hinge cup portion and said hinge arm portion being rotatably connected;
A spring with at least one spring arm and at least one spring coil where said spring arm is tensioned by the spring coil, said spring being mounted substantially outboard of said hinge cup portion, where said spring arm exerts a first biasing force on said hinge arm portion for urging said hinge to a closed position when said hinge is progressed towards a closed position and for urging said hinge arm portion to an open position when said hinge is progressed towards an open position;
And where said spring arm exerts a second biasing force on said hinge arm portion at a predetermined point during the progression of said hinge between an open position and a closed position;
And where the assembly of said hinge arm portion, said hinge cup portion and said spring requires only one hinge pin.

9. The hinge of claim Number 8, where said second biasing force is non-linear in effect.

10. The hinge of claim Number 9 where said second biasing force can be selectively increased or decreased in effect.

11. The hinge of claim Number 10, where said second biasing force results from interference tension asserted on said spring.

12. The hinge as in claim Number 11, where said spring arm extends through an access hole and said interference tension is directly related to the vertical clearance allowed by the access hole for the spring arm.

13. A hinge comprising:
A hinge cup portion for mounting onto a door;
A hinge arm portion for mounting onto a cabinet;
Said hinge cup portion and said hinge arm portion being rotatably connected;
A spring with at least one spring arm and at least one spring coil where said spring arm is tensioned by the spring coil, said spring being mounted substantially outboard of said hinge cup portion, where said spring arm exerts a first biasing force on said hinge arm portion for urging said hinge to a closed position when said hinge is progressed towards a closed position, and for urging said hinge arm portion to an open position when said hinge is progressed towards an open position;
And where said spring arm exerts a second biasing force on said hinge arm portion at a predetermined point during the progression of said hinge between an open position and a closed position and said second biasing force resulting from interference tension applied to said spring arm;
And where the assembly of said hinge arm portion, said hinge cup portion and said spring arm requires only one hinge pin.

14. A hinge as in claim Number 13, where said interference tension is non-linear in effect.

15. A hinge as in claim Number 13, where said interference tension is selectively increasable or decreasable.

16. The hinge as in claim Number 13, where said interference tension results from contact between the spring and at least one access hole.
